(19) United States
(12) Patent Application Publication
(10) Pub. No.: US 2012/0272561 A1
(43) Pub. Date: Nov. 1, 2012

(54) Firearm Enclosure, Method For Constructing The Firearm Enclosure, And A Method For Converting the Firearm Enclosure Into A Blanket

(76) Inventor: Robert F. Risley, Crownsville, MD (US)

(21) Appl. No.: 13/458,929

(22) Filed: Apr. 27, 2012

Related U.S. Application Data
(60) Provisional application No. 61/479,451, filed on Apr. 27, 2011.

(51) Int. Cl. F41A 35/02; B23P 17/04; B23P 11/00

(52) U.S. Cl. 42/96; 29/428; 29/401.1

(57) ABSTRACT

An enclosure that converts to a blanket, a method for constructing the enclosure, and a method for converting the same into a blanket are disclosed. The enclosure includes a central panel, first-side and second-side panels and a sub-assembly. The central panel has a first end and an opposed second end. The central panel further has a transverse edge and an opposed edge. The first-side panel is connected along the transverse edge. The second-side panel is connected along the opposed edge. The sub-assembly, which includes a closing element and a protective element, is connected about a perimeter of the central panel. The closing element remains closed about a substantial portion of the perimeter when a firearm is present in the enclosure. The closing element is opened and the first-side and second-side panels unfolded in an outward manner from the central panel to form the blanket.

### CROSS REFERENCE TO RELATED APPLICATION

This application claims priority to co-pending U.S. provisional application entitled, “Convertible Firearm Enclosure and Blanket,” having Ser. No. 61/479,451, filed on Apr. 27, 2011, and which is entirely incorporated herein by reference.

### BACKGROUND

The present invention relates to firearm accessories and, more particularly, to a fabric firearm case.

Firearm cases have long been used, by sportsmen and collectors, to protect their long-barreled firearms during transport. Typically, such cases are formed in the general shape of the firearm and are made of leather or fabric to protect the firearm. Because waterfowl hunters often use their gun cases in salt marshes and back-bay areas, the exterior fabric of waterfowl gun cases is most often waterproof (by a waterproof material or coating with a waterproofing substance). The firearm, once inserted, is enveloped by a soft absorbent cloth which dries the wood (i.e., the stock) and metal portions of the firearm and protects the same from scratches. Most firearm cases are equipped with various fittings in the form of loops, handles and straps for hanging, lifting and carrying the firearm case. Given the elongated shape of long-barreled firearms, it is convenient to hang the firearm case in an upright orientation and to carry it in a horizontal orientation so the loops handles and straps are attached at appropriate locations to facilitate hanging and carrying in upright and horizontal orientations, respectively.

The need for the firearm case to be supported from its fittings in various orientations demands that the access opening be somewhat secure. Otherwise, the firearm might suddenly fall from the case. Such unintended transfers of the firearm out of the case can damage the firearm or an item struck by the firearm, and when the firearm is loaded could result in potentially serious injury to innocent passersby should the firearm discharge. In this regard, some prior art firearm cases have a single access opening located at or near the distal end of the case where the butt or stock of the firearm rests in the case. Other firearm cases are opened lengthwise along the top seam. In either arrangement, the opening might be closed or secured by a zipper, snaps or straps. However, the extent of the opening is generally minimized (while still allowing withdrawal of the gun) so as to support and retain the firearm in the case.

### SUMMARY

A firearm enclosure, a method for constructing the firearm enclosure and a method for converting the firearm enclosure to a blanket are disclosed.

An embodiment of a method for constructing an apparatus that in a first mode or arrangement serves as a firearm enclosure and in a second mode or arrangement serves as a blanket, includes the steps of constructing a panel having a first end and a second end, the panel having a transverse edge and an opposed edge between the first and second ends, connecting a first-side panel along the transverse edge of the panel, connecting a second-side panel along the opposed edge of the panel, forming an assembly including a protective flap and a closing element and attaching the assembly along a perimeter of the panel, wherein the first-side and second-side panels are extendable in an outward manner from the transverse edge and the opposed edge when the closing element is opened, each of the panel, the first-side panel and the second-side panels including an inner layer and an outer layer with an insulating layer between the inner and outer layers.

An embodiment of a method for converting a firearm enclosure to a blanket includes the steps of opening a firearm enclosure, when present, removing a firearm from the firearm enclosure, removing an adjustable shoulder strap from the firearm enclosure, unfolding a first panel away from the interior of the firearm enclosure, unfolding an opposed panel away from the interior of the firearm enclosure, connecting a first fixed strap to an opposed adjustable strap and placing a first completed strap around the neck and shoulders of a person to be protected by the blanket, connecting a second fixed strap to an opposed adjustable strap and placing a second completed strap about the lower extremities of the person and arranging the adjustable shoulder strap over the exterior surface of the firearm enclosure and around a torso of the person, attaching the adjustable shoulder strap to itself and adjusting as desired to keep the firearm enclosure against the outer clothing of the person.

An embodiment of a firearm enclosure includes a central panel with first-side and second-side panels connected on opposing sides of the central panel. The central panel has a first end and a second end. The central panel has a transverse edge and an opposed edge between the first end and the second end. The first-side panel is connected to the central panel along the transverse edge. The second-side panel is connected to the central panel along the opposed edge. A sub-assembly including a protective element and a closing element is connected about the perimeter of the central panel.

Other devices, methods, features and advantages will be or will become apparent to one skilled in the art upon examination of the following figures and detailed description. All such additional devices, methods, features and advantages are defined and protected by the accompanying claims.

### BRIEF DESCRIPTION OF THE FIGURES

The firearm enclosure and methods for constructing and using the same, as defined in the claims, can be better understood with reference to the following drawings. The components within the drawings are not necessarily to scale relative to each other; emphasis instead is placed upon clearly illustrating the principles involved.

FIG. 1 is a schematic diagram illustrating a perspective view of an embodiment of the firearm enclosure supported by a strap placed over the shoulder of a person.

FIG. 2 is a schematic diagram illustrating a perspective view of the firearm enclosure of FIG. 1 in use as a blanket.

FIG. 3 is a schematic diagram illustrating a side plan view of the firearm enclosure of FIG. 1.

FIG. 4 is a schematic diagram including a top plan view of an embodiment of the interior of firearm enclosure of FIG. 1 in registration with a firearm.

FIG. 5 is a schematic diagram including a top plan view of the interior of the firearm enclosure of FIG. 1 after removal of the firearm and with first-side and second-side panels unfolded.

FIG. 6 is a schematic diagram including a top plan view of the exterior of the firearm enclosure of FIG. 5.

FIG. 7 is a flow diagram illustrating an embodiment of a method for constructing a firearm enclosure that can be converted into a blanket.

FIG. 8 is a flow diagram illustrating an embodiment of a method for converting a firearm enclosure into a blanket.

FIG. 9 is a schematic diagram illustrating the construction of a first sub-assembly of the firearm enclosure of FIG. 1.

FIG. 10 is a schematic diagram illustrating a partial view of a second sub-assembly of the firearm enclosure of FIG. 1.

FIG. 11 is a schematic diagram illustrating a cross-sectional view of a portion of one the panels of the firearm enclosure of FIG. 1.

### DETAILED DESCRIPTION

An enclosure that converts to a blanket, a method for constructing the enclosure, and a method for converting the same into a blanket are disclosed. The enclosure includes a central panel, first-side and second-side panels and a sub-assembly. The central panel has a first end and an opposed second end. The central panel further has a transverse edge and an opposed edge between the first end and the second end. The first-side panel is connected along the transverse edge. The second-side panel is connected along the opposed edge. The sub-assembly, which includes a closing element and a protective element, is connected about a perimeter of the central panel. When arranged as a firearm enclosure, the closing element remains closed about a substantial portion of the perimeter of the central panel. In this arrangement, the enclosure can be used to carry or store a long gun, such as a rifle or shotgun.

In an example embodiment, the closing element is a zipper, although straps, ties, clasps or other devices arranged along the perimeter of the central panel may be employed as alternative elements for closing the enclosure about a rifle or shotgun.

In an example embodiment, the protective element is a flap formed from the same material used to form the central, first-side and second-side panels. The flap is suitably sized to provide a base upon which the opposed sides of the zipper are connected. This connection can be accomplished by sewing, gluing, or fusing the sides of the zipper to the flap.

In an example embodiment, the central, first-side and second-side panels are waterproof and/or water resistant. The waterproof and/or water resistant properties of the panels can be accomplished by adding a membrane that prohibits the transfer of water from a first side to a second side of the panels, treating the material or otherwise modifying the composition of the fibers that comprise the fabric, and/or by applying an agent to an exterior layer of the panels. A host of known compositions can be sprayed or otherwise applied to fabrics to provide water resisting properties to the fabric after the compositions dry.

In an example embodiment, the central, first-side and second-side panels are formed from an inner layer and an outer layer with an insulating layer disposed between the inner layer and the outer layer. In some embodiments, the central, first-side and second-side panels are quilted.

The inner layer can be made with a synthetic material such as nylon or a synthetic fleece or a natural fiber, such as cotton or wool. In still other embodiments the inner layer can be made from blends of all synthetic fibers, all natural fibers, or in some cases blends containing both synthetic and natural fibers. The insulating layer can be made from synthetic materials such as nylon and polyester. In other embodiments, the insulating material may be down (i.e., the fine feathers from the breast of a goose or duck). The outer layer can be made from synthetic materials such as polytetrafluoroethylene (PTFE). These synthetic materials themselves may be arranged in layers with an abrasion resistant outer shell, a structural mesh, a membrane that allows water vapor to traverse the membrane, while resisting the transfer of larger water droplets from one side to the other side of the membrane. Each of these sub-layers that form the outer layer or shell may comprise one or more other synthetic material compounds to provide desired characteristics. Moreover, the outer layer may be treated with a camouflage pattern such that the camouflage pattern is colorfast, stain resistant and resistant to fading from exposure to ultraviolet radiation.

In an example embodiment, the central panel includes a pouch that is arranged to receive and secure a thermal energy source. The thermal energy source can be a hand warmer that is air-activated, a battery powered heater, and/or a liquid fueled (e.g., lighter fluid) metal hand warmer. In some embodiments, the pouch can be lined with napped synthetic materials or wool and arranged to form a hand hold for securing the blanket against the outer clothing of the person to be protected.

In an example embodiment, the central panel is arranged with a removable strap. The removable strap can be disconnected from mounting sites on the exterior surface or outer layer and an end connected to an adjustment element arranged along the removable strap. When connected to itself in this fashion and with the removable strap placed around the blanket and about the torso of the person to be protected, the adjustment element and strap can be arranged to keep the blanket against the person to be protected.

In an example embodiment, the central panel is arranged with a first pair of straps connected to the inner layer near the second end. The first pair of straps can be connected to one another and adjusted as desired to keep the blanket against the lower extremities of the person to be protected.

In another example embodiment, the central panel is arranged with a second pair of straps connected to the inner layer near the first end of the central panel. The second pair of straps can be connected to one another and placed about the neck and shoulders of the person to be protected to keep the blanket secured to the person to be protected. The second pair of straps can be adjusted as desired.

In still another example embodiment, the central panel is arranged with a holder for a game caller. The holder may include a second pouch or a piece of elastic that is sewn or otherwise connected on each end to the surface of the inner layer of the central panel. Alternatively, the holder may be a hook, a snap or other fastener that can be used to connect a mating element on the game caller to the central panel.

When it is cold or raining and a person desires additional protection from the elements than that provided by the person's clothing, the closing element can be entirely opened and the first-side and second-side panels unfolded in an outward manner from the central panel to form a blanket. The blanket may be placed about the person to be protected and/or between the person to be protected and the ground, a hunting blind, a tree, and/or a deer stand, etc. When used as a blanket, the converted firearm enclosure may help a person, for example a hunter, stay warm, dry and sheltered from wind.

In another example mode of operation, the convertible firearm enclosure can be converted into a blanket and folded into a padded seat, head rest and/or cushion.

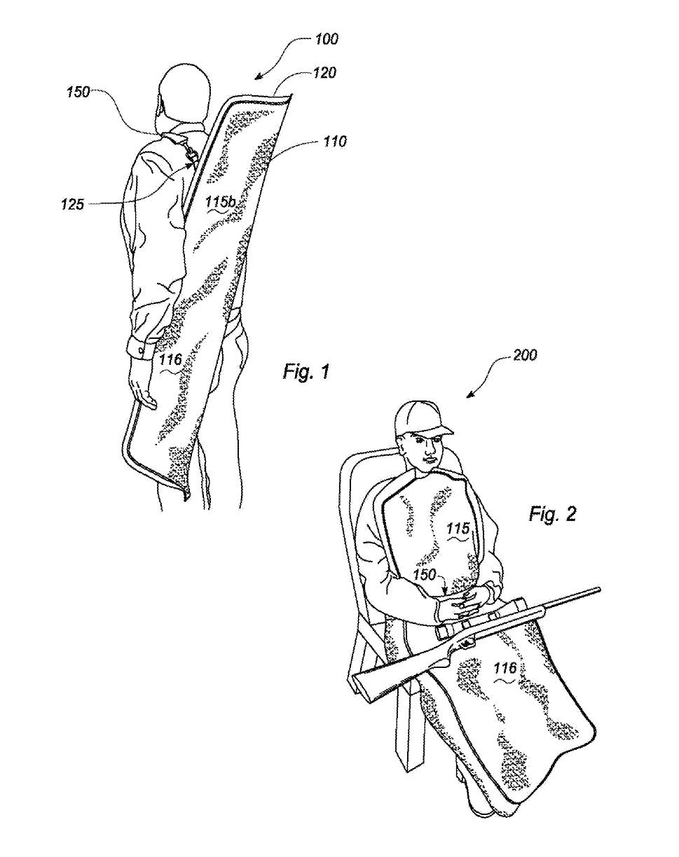

The convertible firearm enclosure having been briefly described above, attention is now directed to the illustrated embodiments in which FIG. 1 shows an embodiment of the firearm enclosure 100 supported by a removable strap 150 placed over the shoulder of a person. The removable strap 150 is connected to the firearm enclosure 100 with a first connector 152 connected at a first mounting site 125. The removable strap 150 includes a second connector located at an opposed end that is hidden from view in FIG. 1. The second connector is connected to the firearm enclosure 100 at a second mounting site, which is also hidden from view. The removable strap 150 can be made from webbing, leather, canvas, or other materials. The removable strap 150 may include a pad (not shown) that can be placed in registration with a person's shoulder to make the removable strap 150 more comfortable when the removable strap 150 is being used to support a firearm in the firearm enclosure 100.

A central panel 110 folds in a clamshell fashion to form a carrying container for a rifle or a shotgun. The carrying container or body includes a first side surface 115b with a second side surface hidden from view. A protective element or flap 120 surrounds the perimeter of the central panel 110. A closing element, protected by the flap 120 and obscured from view in FIG. 1, forms a loop about the perimeter of the central panel 110. As further shown in FIG. 1, an exterior surface 115 of the central panel includes a camouflage pattern 116.

A perspective view of the firearm enclosure 100 in use as a blanket is illustrated in FIG. 2. As shown, the removable strap 150, which has been disconnected from the respective mounting sites 125 has been connected to itself and placed over the exterior surface 115 about the torso of the person 200 to be protected by the blanket.

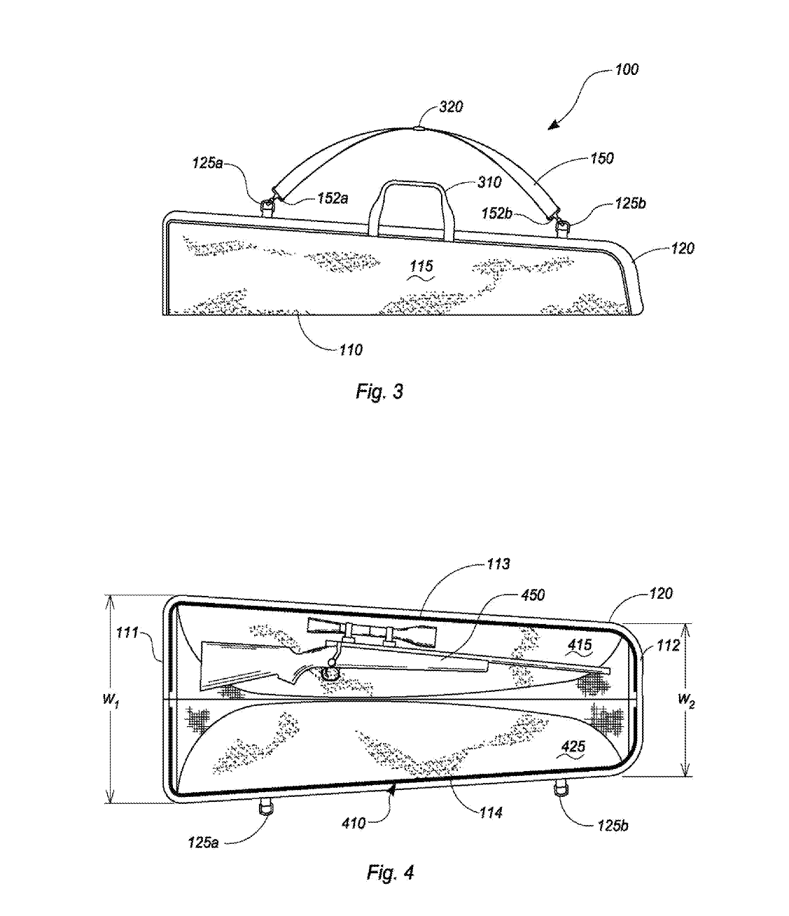

The firearm enclosure 100 is depicted in a side plan view in FIG. 3. The removable strap 150 is connected to the firearm enclosure 100 by a first connector 152a connected at the first mounting site 125a and by the second connector 152b connected at the second mounting site 125b. An adjusting element 320 such as a buckle is located along the removable strap 150. A first handle or first strap 310 is connected at its ends to the central panel 110. A second handle or second strap for carrying the firearm enclosure 100 by hand is connected to the opposite side of the central panel 110 and is hidden from view in FIG. 2. The handles or straps, which can be made from webbing, leather, canvas, plastic or other materials are arranged to receive the hand of an adult and may include respective pads to form a hand hold that is more comfortable than a plain strap of canvas material or a plastic handle.

FIG. 4 includes a top plan view of a rifle 450 in registration with the firearm enclosure 100 when the closing element has been opened and the central panel 110 is unfolded. The central panel 110 has a first end 111 and a second end 112. The first end 111 has a width W₁. The second end 112 has a respective width W₂ that is shorter in length than W₁. The central panel 110 has a transverse edge 113 and an opposed edge 114 between the first end 111 and the second end 112. The protective element or flap 120 and a closing element 410 are located about the perimeter of the central panel 110. A first-side panel 415, connected to the transverse edge 113 of the central panel 110, is folded towards the center of the firearm enclosure 100. A second-side panel 425, connected to the opposed edge 114 of the central panel 110, is folded towards the center of the firearm enclosure 100. In the illustrated embodiment, the closing element 410 is a zipper. In alternative embodiments (not shown) the closing element 410 may comprise straps with opposing buckles, ties, snaps with male and female members, or other fasteners arranged along the perimeter of the central panel 110. In a preferred embodiment, the closing element 410 is a zipper made from non-metallic materials. Such a zipper can be opened and closed in the field without generating unnatural sounds that may frighten nearby animals.

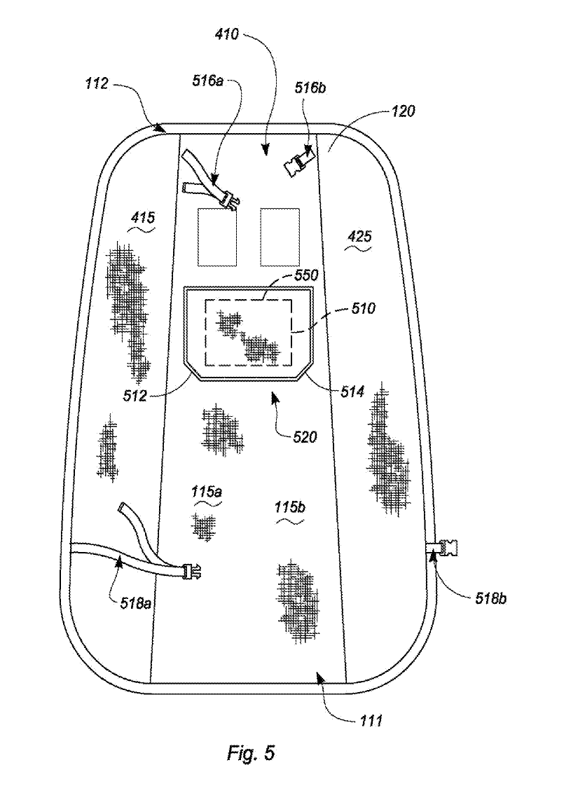

FIG. 5 includes a top plan view of the interior of the firearm enclosure of FIG. 1 after removal of the firearm 450 and with first-side panel 415 and second-side panel 425 unfolded. When unfolded in this manner, a pocket or pouch 510 connected to the inner layer of the central panel 110 is revealed. The pouch 510 is arranged to receive a thermal energy source 550. The pouch 510 has a beveled edge 512 and a beveled edge 514 at opposing sides of an opening 520. The pouch 510 is attached to the central panel 110 along the beveled edge 512, the beveled edge 514 and adjacent edges proximal to the second end 112. The beveled edge 512 and the beveled edge 514 secure the thermal energy source 550 within the pouch 510. The pouch 510 is made from fabric. The pouch 510 can be lined with napped synthetic materials or wool and further used a hand hold for securing the blanket against the outer clothing of the person 200 to be protected. As indicated above, the thermal energy source can be a hand warmer that is air-activated, a battery powered heater, and/or a fuel burning hand warmer.

A first pair of straps 516 is secured to the inner layer proximate to the second end 112. A first strap 516a is secured to the central panel 110 close to the junction of the central panel and the first-side panel 415. The first strap 516a includes an adjustment element and a connector. A second strap 516b is secured to the central panel 110 close to the junction of the central panel 110 and the second-side panel 425. The second strap 516b includes a connector arranged to mate with the connector on the first strap 516a. This first pair of straps 516 can be connected to one another and adjusted as desired to keep the blanket against the lower extremities of the person 200 to be protected.

A second pair of straps 518 is secured to the first-side panel 415 and the second-side panel 425, respectively. A first strap 518a is secured near the outermost edge of the first-side panel 415. The first strap 518a includes an adjustment element and a connector. A second strap 518b is secured near the outermost edge of the second-side panel 425. The second strap 518b includes a connector arranged to mate with the connector on the first strap 518a. This second pair of straps 518 can be connected to one another and placed about the neck and shoulders of the person to be protected to keep the blanket secured to the person 200 to be protected. The second pair of straps 518 can be adjusted as desired.

The firearm enclosure 100 may be further arranged with one or more additional pockets connected along the surface of the inner layer of the central panel 110. These additional pockets are shown in the illustrated embodiment as rectangles and are located near the second end 112. These additional pockets can be arranged to secure a short-range radio communication device, a cellular phone, terrain maps, hunting licenses, game tags, etc. These additional pockets can be located in other locations arranged along the surface of the inner layer of the central panel 110. In addition, these pockets can be arranged with ties, hook and loop fasteners, snaps, zippers or other closing elements to secure items therein.

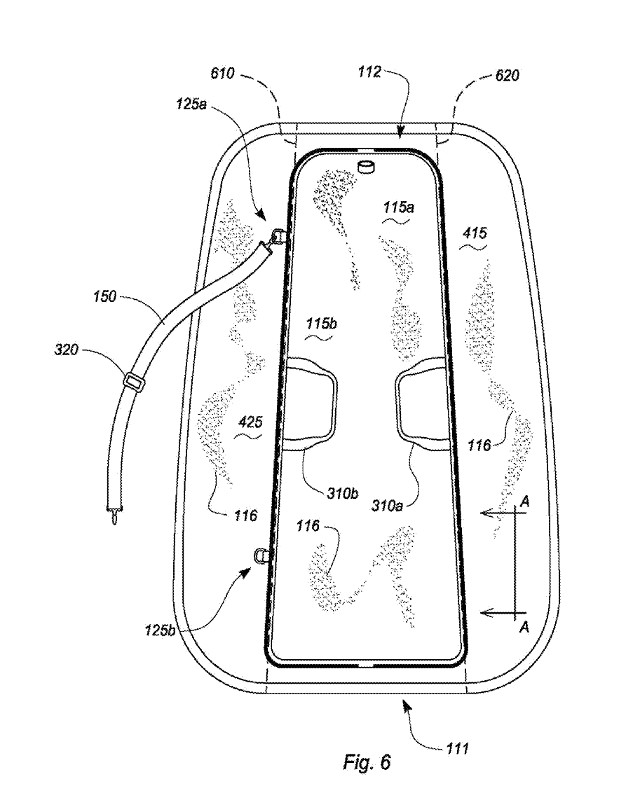

FIG. 6 includes a top plan view of the exterior of the firearm enclosure 100 of FIG. 5. The central panel 110 is connected to the second-side panel 425 along junction 610 and to the first-side panel 415 along a junction 620. Preferably, the junction 610 and the junction 620 are formed by sewing the second-side panel 425 and the first-side panel 415 to the central panel 110 such that the seam or stitching is visible. An observable seam at the junction 610 and an observable seam at the junction 620 can be used as a guide to locate and attach a sub-assembly that includes the closing element 410 and the protective element 120. Otherwise, the sub-assembly may be incorrectly attached to the central panel 110.

A holder 650 is connected to the central panel 110 near the second end 112. The holder 650 is arranged to secure a game caller to the firearm enclosure 100. The holder 650 may include a pouch or a length of elastic that is sewn or otherwise connected at a single location or at each end on the surface of the exterior layer of the central panel 110. Alternatively, the holder 650 may be a hook, a snap or other fastener (not shown) that can be used to connect a mating element on the game caller to the central panel 110.

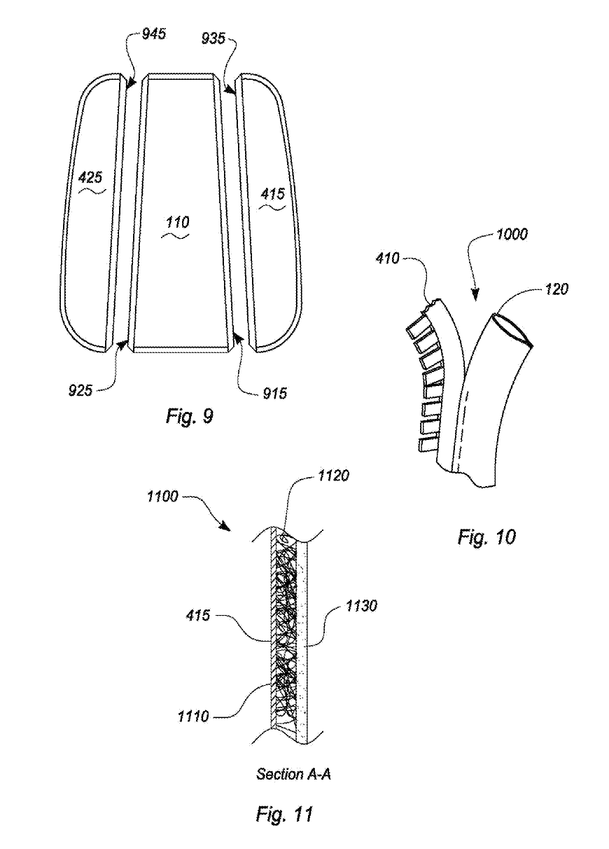

FIG. 9 further illustrates the process of connecting the first-side panel 415 and the second-side panel 425 to the central panel 110 to form a first sub-assembly of the firearm enclosure 100. The central panel 110 includes a hem 915 along a transverse edge and a hem 925 along an opposed edge. The first-side panel 415 includes a hem 935. The second-side panel 425 includes a respective hem 945. In order to form a first sub-assembly, the hem 915 and the hem 935 are arranged to overlap one another and attached. Similarly, the hem 925 and the hem 945 are arranged to overlap one another and are attached. The hems are preferably attached to one another by sewing, as described above to provide an observable seam to serve as a guide when attaching a second sub-assembly to the firearm enclosure 100. Alternatively, the hems may be glued or fused to form the respective junctions. When glued or fused together, a mark or marks may be applied to the exterior of the central panel 100 to identify a suitable location for attaching the sub-assembly that includes the closing element 410 and the protective element 120.

FIG. 10 illustrates the construction of a sub-assembly 1000 from a closing element 410 and a protective element 120. As shown, in the example embodiment, the closing element 410 is a zipper and the protective element 120 is a closed loop of material formed by folding a strip of material over itself and sealing the opposed edges of the strip of material to one another. The protective element 120 can be constructed of the same material used for the outermost layer or shell of the central panel 110, the first-side panel 415 and the second-side panel 425. The sealing or connection can be accomplished by sewing, fusing or gluing the opposed edges along the entire length of the strip of material. As described in association with FIG. 6, the sub-assembly 1000 is arranged in registration with the sub-assembly constructed as shown in FIG. 9 and the two sub-assemblies are permanently connected to each other.

FIG. 11 is a partial cross-sectional view of the first-side panel 415 in the direction of arrows A-A as shown in FIG. 6. Note that each of the central panel 110 and the second-side panel 425 may be cut from a multilayer fabric 1100. As shown in FIG. 11, the multilayer fabric 1100 includes a shell or outer layer 1110 and an inner layer 1130 with an insulating layer 1120 between the outer layer 1110 and the inner layer 1130.

The inner layer 1130 can be a synthetic material (e.g., a washable nylon, a synthetic fleece), a blend of synthetic materials, a natural fiber, e.g., cotton, wool, a blend of natural fibers, or even a blend of synthetic and natural fibers. The insulating layer 1120 can be made from synthetic materials such as nylon and polyester. Alternatively, the insulating layer 1120 may include down. The outer layer 1110 can be made from synthetic materials sometimes referred to by the acronym PTFE. These synthetic materials may be arranged in layers with an abrasion resistant outer shell, a structural mesh, a membrane that allows water vapor to traverse the membrane, while resisting the transfer of larger water droplets from one side to the other side of the membrane. Each of these sub-layers that form the outer layer or shell 1110 may comprise one or more other synthetic material compounds to provide desired characteristics (e.g., resistance to penetration by wind, resistance to abrasion, etc.). Moreover, the outer layer 1110 may have a camouflage pattern 116 applied thereto such that the camouflage pattern 116 is colorfast, stain resistant and resistant to fading from exposure to ultraviolet radiation.

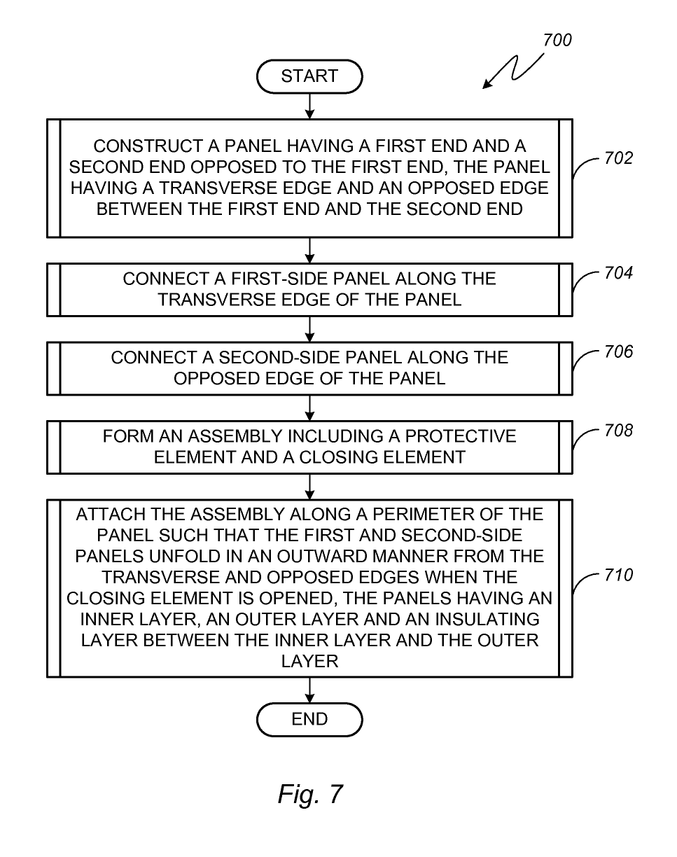

FIG. 7 is a flow diagram illustrating an embodiment of a method for constructing a firearm enclosure. Method 700 begins with block 702 where a panel (e.g., a central panel 110) is constructed. The panel has a first end and a second end with a transverse edge and an opposed edge between the first and second ends. In block 704, a first-side panel (e.g., the first-side panel 415) is connected along the transverse edge of the panel introduced in block 702. In block 706, a second-side panel (e.g., the second-side panel 425) is connected along the opposed side of the panel introduced in block 704. In block 708, an assembly is formed. As indicated in block 708, the assembly includes a closing element (e.g., a zipper) and a protective element (e.g., a flap of material). The protective element prevents and/or prohibits interference between foreign items and the zipper. In block 710, the assembly is attached to the panel introduced in block 702. As indicated in block 710, the first-side and second-side panels are extendable in an outward manner from the transverse edge and the opposed edge when the closing element is opened with each of the panel from block 702 and the first-side and second-side panels being formed or constructed of a multilayer fabric including an inner layer and an outer layer, with an insulating layer between the inner and outer layers.

It should be understood, that the separate steps presented in the blocks 702 and block 708 need not be performed in the illustrated sequence. That is, the assembly constructed in block 708 can be assembled separate from the panel in block 702. It should be further understood that the separate steps presented in blocks 704 and 706 need not be performed in the illustrated sequence. For example, final assembly of the firearm enclosure 100 can be accomplished by bringing a first assembly comprising the panels in registration with a second assembly including the closing element and the protective element and attaching the first assembly and the second assembly to one another.

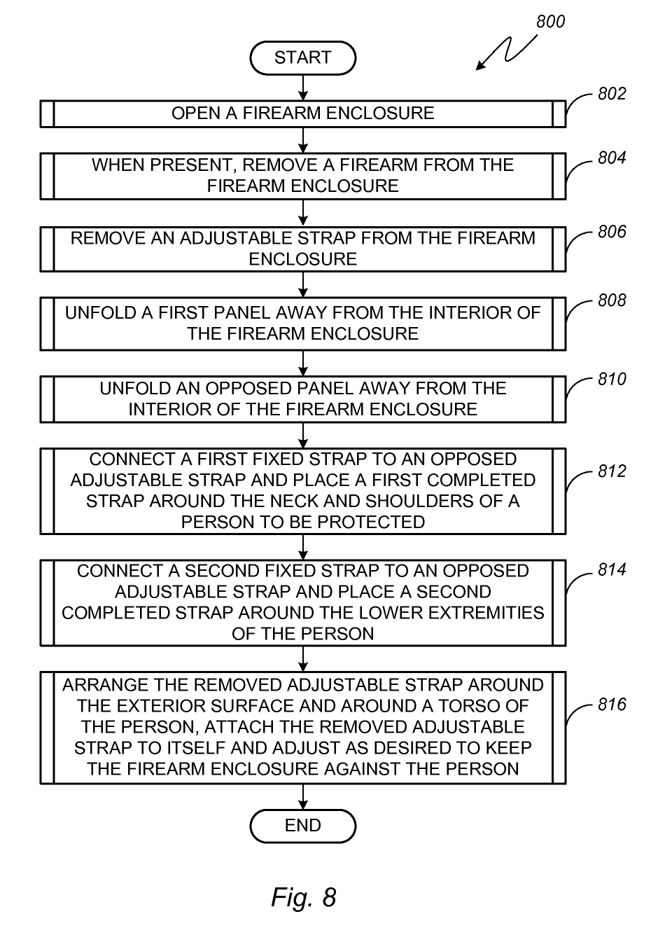

FIG. 8 is a flow diagram illustrating an embodiment of a method for converting a firearm enclosure 100 so that the firearm enclosure 100 can be used as a blanket. Method 800 begins with block 802 where the firearm enclosure 100 is opened. As indicated in block 804, when a firearm is present within the firearm enclosure 100 it is removed before performing any of the functions presented in the subsequent blocks. Thereafter, as indicated in block 806, an adjustable strap is removed from the firearm enclosure 100. In blocks 808 and 810 first and opposed panels are unfolded away from the interior of the firearm enclosure 100. In block 812, a first fixed strap is connected to an opposed adjustable strap to assemble a completed strap that is placed about the neck and shoulders of a person to be protected by the blanket. The completed strap can be adjusted at any time as may be desired. In block 814, a second fixed strap is connected to an opposed adjustable strap to assemble a second completed strap that is placed about the lower extremities of the person to be protected by the blanket. The second completed strap can be adjusted at any time as may be desired. In block 816, the adjustable strap, which was removed from the enclosure in block 806, is placed around the exterior surface of the firearm enclosure 100 and around the torso of the person to be protected by the blanket. As further indicated in block 816, the adjustable strap is connected to itself and adjusted as desired to keep the firearm enclosure against the person to be protected.

The separate steps presented in blocks 808 and 810 need not be performed in the illustrated sequence. In addition, the steps presented in block 812 and 814 need not be performed in the illustrated sequence.

The foregoing description has been presented for purposes of illustration and description. It is not intended to be exhaustive or to limit the scope of the apparatus or methods to the precise forms disclosed. Modifications or variations are possible in light of the above teachings. However, the embodiments were chosen and described to enable one of ordinary skill to make and use the present apparatus and methods. All such modifications and variations are within the scope of the appended claims when interpreted in accordance with the breadth to which they are fairly and legally entitled.

What is claimed is:

1. An apparatus, comprising:
a central panel having a first end and a second end, the central panel having a transverse edge and an opposed edge, the transverse and opposed edges together with the first and second ends substantially forming a perimeter of the central panel;
a first-side panel connected to the central panel along the transverse edge;
a second-side panel connected to the central panel along the opposed edge; and
a sub-assembly connected about the perimeter of the central panel, the sub-assembly including a closing element and a protective element.

2. The apparatus of claim 1, wherein central, first-side and second-side panels include a membrane that prohibits the transfer of water through the panels.

3. The apparatus of claim 1, wherein the closing element is a zipper connected to the protective element.

4. The apparatus of claim 1, wherein the protective element is a flap of fabric.

5. The apparatus of claim 1, wherein the central, first-side and second-side panels include an inner layer, an outer layer and an insulating layer disposed between the inner and outer layers.

6. The apparatus of claim 5, wherein the inner layer is constructed from a fabric consisting of one or more of synthetic fleece, wool, and cotton.

7. The apparatus of claim 5, wherein the outer layer comprises a camouflage pattern.

8. The apparatus of claim 5, wherein the outer layer is treated with a waterproofing agent.

9. The apparatus of claim 5, wherein the outer layer is resistant to abrasion.

10. The apparatus of claim 5, wherein the outer layer is resistant to stains.

11. The apparatus of claim 5, wherein the outer layer is colorfast and resistant to fading due to exposure to ultraviolet radiation.

12. The apparatus of claim 5, wherein the central panel further comprises:
a holder connected to a surface of the outer layer and arranged for securing a game caller.

13. The apparatus of claim 5, further comprising:
a removable strap with an adjusting element disposed between connectors, wherein when the removable strap is detached from corresponding mounting sites, the connectors are attached to each other when the removable strap is placed against the outer layer, the adjusting element adjusted as desired to keep the apparatus against a torso of a person to be protected.

14. The apparatus of claim 5, further comprising:
a first pair of straps connected to a surface of the inner layer of the central panel proximate to the second end and arranged to adjustably secure the apparatus against the lower extremities of a person to be protected.

15. The apparatus of claim 14, further comprising:
a second pair of straps connected to a surface of the inner layer of the central panel proximate to the first end and arranged to adjustably secure the apparatus about a neck and shoulders of a person to be protected.

16. The apparatus of claim 5, wherein the central panel further comprises:
a pouch connected to a surface of the inner layer and arranged for receiving a thermal energy source.

17. The apparatus of claim 16, wherein the pouch provides a hand hold for retaining the apparatus against an outer layer of clothing of a person.

18. The apparatus of claim 1, wherein the central panel, first-side and second-side panels are cut from a single piece of fabric.

19. A method for constructing an apparatus that in a first mode serves as a firearm enclosure and in a second mode serves as a blanket, the method comprising:
constructing a panel having a first end and a second end, the panel having a transverse edge and an opposed edge between the first end and the second end;
connecting a first-side panel along the transverse edge of the panel;
connecting a second-side panel along the opposed edge of the panel;
forming an assembly including a protective element and a closing element; and
attaching the assembly along a perimeter of the panel, wherein the first-side and second-side panels are extendable in an outward manner from the transverse edge and the opposed edge when the closing element is opened, each of the panel, the first-side panel and the second-side panels including an inner layer and an outer layer with an insulating layer between the inner and outer layers.

20. A method for converting a firearm enclosure to a blanket, comprising:
opening a firearm enclosure;
when present, removing a firearm from the firearm enclosure;
removing an adjustable shoulder strap from the firearm enclosure;
unfolding a first-side panel away from the interior of the firearm enclosure;
unfolding a second-side panel opposed to the first-side panel away from the interior of the firearm enclosure;
connecting a first strap to an opposed adjustable strap, the first strap and opposed adjustable strap proximal to a first end of the firearm enclosure to form a first assembly;
placing the first assembly around the neck and shoulders of a person to be protected by the blanket;
connecting a second strap to an opposed adjustable strap, the second strap and opposed adjustable strap proximal to a second end of the firearm enclosure to form a second assembly;
placing the second assembly around the lower extremities of the person; and
arranging the adjustable shoulder strap over the exterior surface of the firearm enclosure and around a torso of the person, attaching the adjustable shoulder strap to itself and adjusting as desired to keep the firearm enclosure against the outer clothing of the person.
